(19) United States
(12) Patent Application Publication
(10) Pub. No.: US 2002/0038263 A1
(43) Pub. Date: Mar. 28, 2002

(54) Business method relating to roaming sales of products customized to the shape of an object

(76) Inventor: Robert Massen, Ohningen (DE)

Correspondence Address: NIXON PEABODY, LLP, 8180 GREENSBORO DRIVE, SUITE 800, MCLEAN, VA, 22102, US

(21) Appl. No.: 09/954,431

(22) Filed: Sep. 18, 2001

(30) Foreign Application Priority Data
Sep. 23, 2000 (DE) 100 47 804.2

(51) Int. Cl. G06F 17/60

(52) U.S. Cl. 705/27

(57) ABSTRACT

A merchandising method for roaming merchandising of products which are customized to the 3D body shape of a customer wherein a sales person is furnished with a collection of elastic envelopes marked for photogrammetric analysis with which he clads the pertinent body part of the customer. The thus clad body part is imaged with overlapping images obtained with the aid of a camera but in any position in space. From these images the 3D data of the corresponding body part as needed for customized manufacture is established locally or following communication to a host computer of the retailer or manufacturer.

### FIELD OF THE INVENTION

The present invention relates to a method of roaming merchandising of products and, more particularly, to such a method wherein the products are customized to the body shape of the customer.

### BACKGROUND OF THE INVENTION

Merchandising products needing to be customized to the body shape of the customer, such as shoes, garments, orthopaedic supports, eyewear frames and the like, is currently done in a specialized outlet store where an experienced sales person obtains the body dimensions as necessary, for example, for a ready-to-wear or made-to-measure garment which is then selected from stock or fabricated individually. In mail-order purchasing, where the customer selects from a printed catalog or an electronic catalog via the Internet, with no expert sizing and customer consultation, returns as high as 50% due to misfits are currently experienced. Such high return percentages are extremely expensive for mail-order business and are a major obstacle to this form of merchandising.

A whole series of methods are known for obtaining the body dimensions of customers with the aid of electronic scanning either in a special outlet store or in special scanner shops. Thus, for example, the German company Tecmath, Kaiserslautern (www.tecmath.de) installs body scanners in department stores for the purpose of electronically scanning the body of the customer and determining from the resulting electronic 3D data the suitable product or initiating fabrication made-to-measure. The Dutch company Possen (www.possen.com) has installed such a 3D body scanner in a mobile truck container permitting sizing at locations conducive to merchandising outside of specialist outlets and scanner shops and communicating this data to suitable producers. The Belgian company Mezzura (www.mezura.com) has installed in various shoe stores digitizers for electronically scanning the foot for high quality customized shoe production.

All of these known methods involve high expense in staffing, space and hardware requirements. The corresponding methods, working on the basis of multiple triangulation by means of cameras, laser or stripe projectors, necessitate optical hardware of relatively large dimensions which can only be operated by skilled personnel. The costs involved are in the order of 20,000 to 200,000 Euro for the scanner alone without figuring the space requirement for the permanent fixtures or the expense for transportation in a truck container. Where these scanners come into contact with the body, stringent hygiene and disinfection code requirements need to be satisfied which, in, turn significantly add to the costs of such hardware.

This automatically restricts the application of such scanners. In particular, they are unsuitable for use in cost-effective roaming door-to-door sales, at public markets, in medical, paramedical or mobile medical treatment facilities. Such methods of merchandising are, however, wide-spread in many countries such as in the United States, in emerging economies, etc.

### SUMMARY OF THE INVENTION

The object of the present invention is to provide a system for roaming merchandising and ordering customized products from producers of such products, including retailers and custom manufacturers, and initiating the actions necessary commercially for selecting a suitable product from available inventory or making it to measure. The method of the invention permits establishing the required 3D body shape of the part of the body involved, independent of specially configured sales rooms, without requiring highly skilled personnel and with the advantage of extremely low investment and operating costs.

In patent EP 0760622, corresponding to U.S. Pat. No. 5,911,126, MASSEN describes a method and an assembly for sensing a part of the body three-dimensionally without such technical apparatuses as calibrated laser or stripe projection scanners. This is accomplished by cladding the corresponding body part with a close-fitting envelope provided with marks or patterns, random or regular, permitting photogrammetric analysis and imaging this body part with the aid of several cameras from various positions unknown and uncalibrated in space or synonymous with a single camera from various positions assumed in sequence, by means of overlapping images. By the known photogrammetric methods the position of the marks in space can be established and thus a punctual 3D model of the body part established suitable for selecting a fitting product or for making it to measure. Such a method is suitable for use in connection with the present invention and, accordingly, the disclosure of said aforementioned U.S. patent is incorporated herein by reference.

In accordance with the invention, cost-effective roaming merchandising of products which need to be customized to the body shape of the customer is achieved by the sales person having marked elastic envelopes for enveloping the pertinent body part and a camera with which the sales person obtains, from free positions in space, overlapping images of the body part of the customer, by establishing the 3D body data of the customer, as necessary, for implementing the customer's merchandise order from the images by a photogrammetric method and by making use of this 3D data for selecting the suitable product from available stock of, or for making it to measure by, the producer.

### DESCRIPTION OF THE PREFERRED EMBODIMENTS

The gist of the invention will now be detailed by way of example in the roaming merchandising of customized shoes, it being understood that it is not intended by such example to restrict the invention in any way or the products to which it is applicable. Likewise, as an example, and without intending to be restricted hereto, the merchandising of such customized products is explained in connection with the system of door-to-door or “AVON”-type merchandising as widely practiced in the United States and in many other countries. At this time these concepts are highly successful in merchandising cosmetics, cleaning products, household appliances, etc. In Germany, for example, the Vorwerk Company has a high volume business in the sale of vacuum cleaners by this merchandising system. Body customized products, however, are seldom merchandised by this system since a roaming sales person is, typically, unable to carry an extensive selection of stock.

In accordance with the invention, a sales person for customized footwear merely requires to be equipped with a few elastic socks marked photogrammetrically, for example, in accordance with the above-identified U.S. patent as well as with imaging apparatus, such as a traditional or digital photo apparatus or a video camera. To establish the foot shape of the customer concerned the sales person clads the foot with the marked elastic sock and produces a series of overlapping images of the foot clad as such. From these images the 3D data of the foot is obtained and it is this data that is used to select the suitable shoes from retailer or manufacturer stock or for making them to measure. In accordance with the invention the elastic and marked envelopes are configured so that they are a tight fit on the body part to be imaged. The tight fit may be enhanced, in accordance with the invention, by making use of an adhering agent, such as an adhesive.

In accordance with one embodiment of the invention, the camera used is a digital camera communicating with a handheld computer via which the sales person is able to communicate from the customer location over the telephone system or via a wireless modem the images for 3D analysis to a host computer operated, for example by the producer. The availability of new generation UMTS wireless telephones incorporating video cameras for wireless image communication further simplifies hardware needing to be carried by the sales person, i.e. one such wireless phone being all that is required in addition to the marked envelopes for implementing the merchandising method of the present invention.

In accordance with the invention, in addition to the images of the clad body part, other data pertinent to customizing the product and customer contact, such as sizings, habits, mobile activities, purchasing habits and other personal data is also obtained and communicated, together with the image data, to the customer data base which is saved in the producer host computer.

It is to be noted that merchandising customized footwear, as hereinbefore described, is but one example of how the method in accordance with the invention can be put to use. There are a wealth of other examples of products, such as fashion and sports eyewear (3D imaging of facial and nose contour), shirts and pants (3D imaging of the trunk and buttocks by cladding with an elastic marked envelope), orthopaedic articles, e.g., arch supports (3D imaging of foot bed enveloped with an elastic marked sock), anatomically customized seating surfaces (3D imaging the same as for pants), elastic stockings as used in the treatment of varicose veins (3D imaging of leg clad with a marked elastic envelope), etc. all of which can be likewise merchandised by the method in accordance with the invention.

It is to be noted, furthermore, that the gist of the invention is not at all restricted to door-to-door merchandising. Rather, as will be appreciated, it relates to any point of sale where it is not possible to install a usually complex optical body or body part scanner.

It is particularly in the medical field that the corresponding 3D data can be obtained with very little effort and complication for patients confined to a hospital bed, and in remote ward situations, by nursing personnel for communication to producers. This makes the present merchandising model also of great interest to the Third World since it can be implemented by local personnel, NGOs operative there and in similar communities lacking a good infrastructure. One particularly illustrative example of how this invention can be put to use is in the field of on-the-spot 3D imaging of body parts of land mine victims having a severed limb, in enabling production of complicated parts of the prosthesis adapted to the severed limb, by communication to a regionally remote manufacturer. 3D imaging of the leg of patients requiring stockings for the treatment of varicose veins can now be implemented by the method in accordance with the invention with high accuracy and very little technical expenditure, the recorded 3D data representing not only the basis for making the stocking to measure but also representing a valuable 3D document for the medical file of the patient.

In accordance with the invention the very same camera which is used for imaging the body part covered by the marked elastic envelope can also be employed to document the unclothed body part in supporting the basis in knowledge for selecting the suitable product or making it to measure by visual anatomical and medical findings.

There are a wealth of applications for the method in accordance with the invention. Thus, the body part of the customer may involve the leg, requiring the use of an elastic marked stocking as the envelope. In this case, products which might be ordered by the customer could include, for example, elastic stockings, prostheses, rails or support shells for the leg or knee of the customer. The body part may be, for example, the back of the customer, in which case an elastic T-shirt functions as the envelope. The products which might be involved in such a case could include, for example, orthopaedic back supports or the hard shell back protector of a motorbike rider. It is conceivable that the elastic T-shirt could also be used for digitizing the trunk of the customer, in which case the products involved might be garments, corsets, vests (for instance bullet-proof vests) or scuba diving wet suits. In like manner, the body part of the customer might involve the lower body in which case a marked panty-hose would serve as the envelope. The products in this case could be, for example, pants of all kinds.

What is claimed is:

1. A method of merchandising of a product customized to the shape of an object for which a customer wishes to purchase a shape-customized product, comprising the steps of:
furnishing a sales person with at least one imaging apparatus and at least one envelope provided with marks for analysis by a photogrammetric system;
sales person proceeding to the location of an interested potential customer;
sales person arranging for said object of said customer to be enveloped by said envelope;
sales person arranging for obtaining with said imaging apparatus at least two images of different views of said object;
analyzing said images with the aid of said photogrammetric system and establishing therefrom the shape of said object of said customer and the suitable shape of said product for customizing said product to the shape of said object; and
conveying said customized product to said customer.

2. The method as set forth in claim 1 wherein, after establishing the shape of said product customized to the shape of said object, said product is made to measure on the basis of said established shape before said product is conveyed to said customer.

3. The method as set forth in claim 1 wherein after establishing the shape of said product customized to the shape of said object, a suitable product is selected from a retail stock before said product is conveyed to said customer.

4. The method as set forth in claim 1 wherein said imaging apparatus is a digital camera.

5. The method as set forth in claim 1 wherein said object of said customer is a body part of said customer.

6. The method as set forth in claim 5 wherein said body part is a foot of said customer, said product is a shoe and said envelope is a sock.

7. The method as set forth in claim 5 wherein said body part is a leg of said customer and said envelope is a stocking.

8. The method as set forth in claim 5 wherein said body part is the back of said customer, said product is an orthopaedic back support or a hard shell back protector and said envelope is a T-shirt.

9. The method as set forth in claim 5 wherein said body part is the trunk of said customer, said product is a garment therefor and said envelope is a T-shirt.

10. The method as set forth in claim 5 wherein said body part is the lower part of the body of said customer, said product is pants and said envelope is a panty-hose.

11. The method as set forth in claim 1 wherein said customer location is the home of said customer.

12. The method as set forth in claim 1 wherein said envelope is elastic.

13. The method as set forth in claim 1 wherein said envelope is provided with an adhering means for facilitating a close fit on said object.

14. The method as set forth in claim 1 wherein said images overlap.

15. The method as set forth in claim 1 wherein said images represent data communicated from said sales person to a host computer at the producer's location and in which said images are analyzed with the aid of said photogrammetric system.

16. The method as set forth in claim 1 including said sales person accessing a product catalog for permitting said customer to select said product.

17. The method as set forth in claim 1 wherein said sales person accesses said product catalog via a computer with Internet connection.

18. The method as set forth in claim 17 wherein said computer is integrated in a mobile phone.

19. The method as set forth in claim 18 wherein a digital camera is additionally integrated in said mobile phone.

20. The method as set forth in claim 1 wherein, in addition to said images, personal customer data is also recorded by said sales person.

21. The method as set forth in claim 1 wherein the step of arranging for said object to be enveloped comprises instructing said customer how to envelope said object.

22. The method as set forth in claim 1 wherein the step of arranging for obtaining images comprises instructing said customer how to obtain said images.
